(19) United States
(12) Patent Application Publication
(10) Pub. No.: US 2004/0110116 A1
(43) Pub. Date: Jun. 10, 2004

(54) Equestrian rein aids training system

(76) Inventors: Joan Beverly Pretty, Lanark (CA); Cara Louise Makort, (US)

Correspondence Address: Cara Makort, RR # 1, 973 Churchill Rd., Perth, ON, K7H 3C3, CA

(21) Appl. No.: 10/310,483

(22) Filed: Dec. 6, 2002

(51) Int. Cl. G09B 9/00; A63B 69/00

(52) U.S. Cl. 434/247; 434/258

(57) ABSTRACT

An apparatus incorporating a control system and force and/or position feedback sensor apparatus for determining the orientation, motion and related sensing stimuli required to simulate correct rein aids and hand placement of various equitation disciplines. Includes one or more force and/or position sensor(s), operably coupled to a controller means. The controller means is coupled to receive data from the force and/or position sensor means and for comparing the force and/or position data to previously stored rules and data which in turn generates output signals based on the comparison(s). Output signals comprising a position feedback signal are coupled to a stimulator means, and are further coupled to a display and audio generation means. A stimulator means is coupled to create motion and resistance feedback stimuli to the force and/or position sensor(s) in relation to the controller output signal.

### FIELD OF THE INVENTION

The present invention relates to a device used to train equestrian riders on the use of rein aids and hand placement. More particularly, the present invention relates to a force and position feedback sensor apparatus for determining the orientation, motion and related sensing stimuli required to simulate correct rein aids and hand placement of various equitation disciplines. It includes a controller comprising electronics having one or more said position feedback sensor inputs, operably coupled to relate equitation hand position into positions in space with relation to time. The controller means comprises an output for transmitting and receiving data to or from a personal computer. Data relayed between the controller means provides a signal to the computer for comparing said hand placement to rules and other data for the purpose of training and corrective action display and audio feedback to the learning equestrian rider.

### BACKGROUND OF THE INVENTION

Equestrian riders tend to consider their hands as an aid that controls the horse in the same manner as the steering wheel directs an automobile. This erroneous statement often manifests itself when a novice rider flaps and waves the reins in a futile attempt to make the horse move. In reality, harsh movement or stiffness in the riders arms and hands will cause the horse to become tense, rigid or discontent. A rider who exhibits such conditions is said to have “bad hands”.

A rider who exhibits the opposite state is said to have “good hands”. Good hands support and work in conjunction with other riding “aids” such as a balanced seat, proper legs, tact and communication with horse that results in harmony between the horse and rider and to shape the fluidity of movement of horse.

It takes considerable practice, patience and good teaching to learn that reins are not intended as a means of support and balance for riding the horse, but rather as a means of communication to “listen to” or feel the horses' movements and to translate the riders commands precisely via the bridle.

The communication interplay between the horse and rider become more complex as one understands the that effective hands follow the horse's mouth independently from the rest of the body, modulating the give and take to be “pulling” or relaxed depending on the riding gait, on a moment by moment basis.

In Western style riding, rein communication takes places with the pressure on the reins very relaxed, almost slack. However, the weight of the reins alone communicates through the bit to transmit rider commands to the horse's sensitive mouth. In English style riding, the rein is held more firmly or is said to be “in contact”.

Regardless of whether the reins are firmly held or slack, there is a comfort zone that tells the horse this is the requested position to carry his head. When the rider is consistent in defining the target area, the rider and horse are in harmony. The requested position will change as to a function of gait, terrain, or a curve in the track. It is a moment by moment defined area where the hands are in rhythm with the horse body motion and the rider remains balanced in their perfect “seat”.

A reader who is a skilled equestrian rider will understand the subtle relationship between the horse and rider and will further understand the importance of the preceding statements. A reader who is not a skilled rider will find these comments difficult to visualise and will almost certainly not have the ability to execute the subtle motion required to reach riding harmony, without considerable training and practice.

While many novice riders do work on schooled horses, the amount of time an instructor can provide on this important issue is both economic and practical. Many hours of specifically hand training can be expensive. Additionally an instructor may wish to protect a horses mouth from accidental tugging by uneducated hands. Further, novice riders may not have developed their balance in the saddle “or seat”. An insecure seat causes tension, gripping and general instability in the reins during periods of threatened balance.

One prior art system used to educate novice riders in good hand presentation, utilises a small elastic material sewn into the reins, including a loop of leather. Such a system allows for the rein to stretch with increasing tension, to a maximum point controlled by the leather loop. When the elastic has expanded to the maximum point, the leather loop is also elongated causes the rein to become stiff.

Training systems that rely on elastic rein components may protect the horse from accidental or excessive pulling of the horses' mouth, but will not teach the novice rider how to develop “riding harmony” as disclosed above.

Another known system comprises an electro-mechanically operated, life size, model horse, operably connected to a drive mechanism and control means which approximately simulates the movements and cadence of a real horse. Such a system may also contain rein control apparatus, wherein pulling on the rein will either stop or slow the movement of the model horse.

Training systems incorporating such a life size model may acquaint the very young or novice rider with the basic motions of a horse, but will not provide realistic and subtle interactions necessary for proper rein control. Additionally, such systems are likely to be too expensive and bulky for many riders.

Accordingly, it is an object of the present invention to provide a control system incorporating a force and position/feedback sensor apparatus for determining the orientation, motion and related sensing stimuli required to simulate correct rein aids and hand placement of various equitation disciplines.

It is a further object of the present invention to include a controller comprising electronics having one or more said position feedback sensor inputs, operably coupled to relate equitation hand position into positions in space with relation to time. The controller means comprises an output for transmitting and receiving data to or from a personal computer. Data relayed from the controller means provides a signal to the computer for comparing said hand placement to rules and other data for the purpose of training and corrective action display and audio feedback to the learning equestrian rider.

It is a further object of the present invention to include feedback from the computer to the controller and position feedback sensor to create motion and resistance stimuli to the user, such stimuli representing the motion felt on the rein as a result of the horses' cadence, head and mouth movements.

One preferred embodiment of the present invention contemplates the use of “joy stick” motion axis sensors mounted on a suitable frame to simulate correct hand placement of the learning rider. Such an arrangement may be utilised to provide position feedback signals to a controller and computer means.

A person skilled in the art would understand that such an arrangement of position feedback sensor, controller and computer means provides for a “hands” unique training system for novice and other equestrian riders wishing to develop “good hands”, without causing harm to the horse and unnecessary training expenses. Furthermore, there are other means of assembling such components into a training system suitable for the end system application, without departing from the scope of the present invention.

### SUMMARY OF THE INVENTION

According to an aspect of the present invention, there is provided an apparatus incorporating a control system and force and/or position feedback sensor apparatus for determining the orientation, motion and related sensing stimuli required to simulate correct rein aids and hand placement of various equitation disciplines, the apparatus comprising:

one or more force and/or position sensor(s), operably coupled to a controller means;

A controller means, coupled to receive data from said force and/or position sensor means and for comparing said force and/or position data to previously stored rules and data, generating output signals based on said comparison(s) and, said output signals comprising a position feedback signal coupled to a stimulator means, and further coupled to a display and audio generation means;

A stimulator means coupled to create motion and resistance feedback stimuli to the force and/or position sensor(s) means in relation to said controller output signal.

According to another aspect of the invention, there is further provided a method for incorporating a control system and force and/or 90 position feedback sensor apparatus for determining the orientation, motion and related sensing stimuli required to simulate correct rein aids and hand placement of various equitation disciplines, the method comprising:

one or more force and/or position sensor(s), operably coupled to a controller means;

A controller means, coupled to receive data from said force and/or position sensor means and for comparing said force and/or position data to previously stored rules and data, generating output signals based on said comparison(s) and, said output signals comprising a position feedback signal coupled to a stimulator means, and further coupled to a display and audio generation means;

A stimulator means coupled to create motion and resistance feedback stimuli to the force and/or position sensor(s) means in relation to said controller output signal;

the method comprising the steps of;

(a) set-up default program parameters;

(b) wait for user program request and start command;

(c) load program module and audio/visual data;

(d) read position sensor(s) data (e) Modify program data, position sensor feedback signal, audio and visual data based on position sensor(s) data and program rules.

Other advantages, objects and features of the present invention will be readily apparent to those skilled in the art from a review of the detailed description of the preferred embodiment in conjunction with the accompanying drawings and claims.

### BRIEF DESCRIPTION OF THE DRAWINGS

The embodiments of the invention will now be described with reference to the accompanying drawings, in which:

FIG. 1 is a view of a typical horse and rider where riding posture is incorrect and rein aids and hand position are compromised;

FIG. 2 is a view of a typical horse and rider where riding posture is correct and rein aids and hands are in the ideal position, the rider is in “harmony”;

FIG. 3 shows several views of holding the reins, both incorrectly and correctly;

FIG. 4 shows correct hand placement in both English and Western riding disciplines;

FIG. 5 shows a prior art apparatus for assisting the novice rider develop “good hands” by the insertion of an elastic strip in the rein;

FIG. 6 shows one embodiment of the present invention installed on a table, being operated by a learning rider seated in a chair;

FIG. 7 shows a detailed drawing of one preferred embodiment of the position feedback sensor, used to simulate the reins; and

FIG. 8 is a flow chart illustrating the operational sequence and input and output functions of the controller of the present invention.

With respect to the above drawings, similar references are used in different Figures to denote similar components.

### DETAILED DESCRIPTION OF THE INVENTION

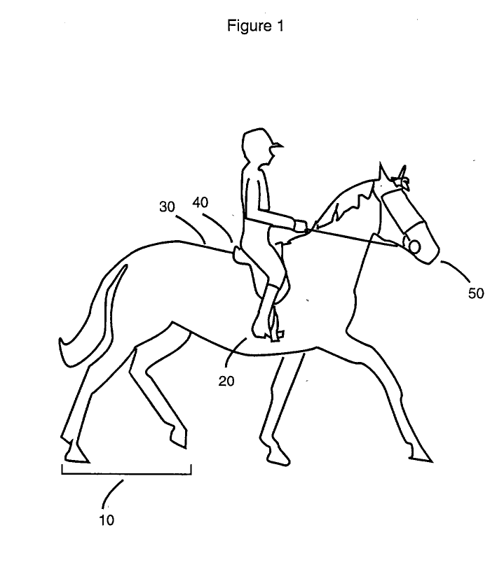

Referring to FIG. 1, there is shown a typical horse and rider wherein the rider skill is low owing to a poor seat and improper hand placement. Tight ankles (raised heels) 20 and stiff hips 40 cause the rider to have a poor seat and balance. Rigidity in the legs and hips often causes bracing of the arms, resulting in incorrect rein placement and the horse not “taking the bit” 50. Such incorrect riding “aids” cause short, stiff strides 10 and a hollow back 30.

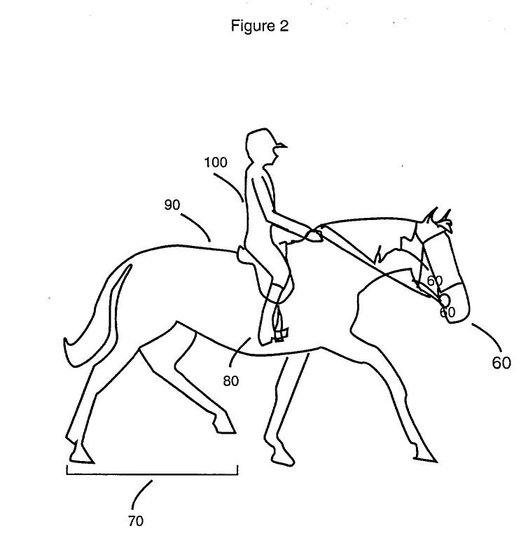

Referring now to FIG. 2 there is shown a horse and rider considered to be “on the bit” or in harmony. This rider has freedom in the ankles (lower heels) 80 and hips 100 providing a good “seat” and balance. A rider with surer balance may now concentrate on proper rein aids 60 which gives the horse more confidence, working a longer stride 70 and better back elevation 90.

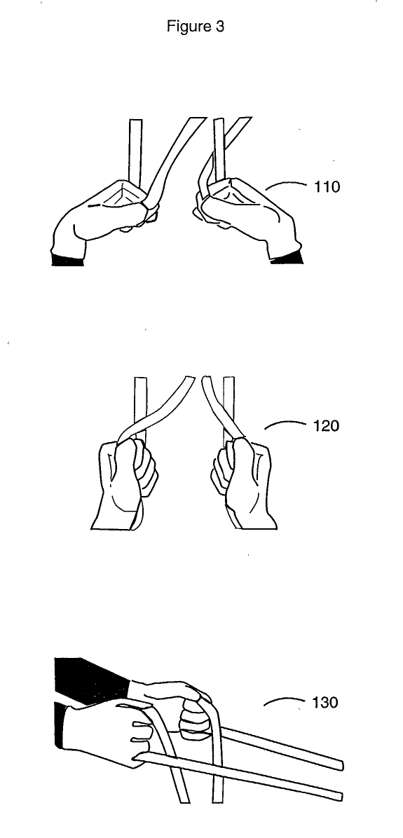

FIG. 3 diagrams typical hands to rein placement where drawing 110 shows the hands stiffly locked inward, and drawing 120 having the hands stiffly locked outwards. Such hand placement removes the softness and feedback between the rider and horses' mouth. Drawing 130 shows the correct hand placement to provide the sensitivity required to work the horse into the harmonious or “on the bit” position discussed in FIG. 2.

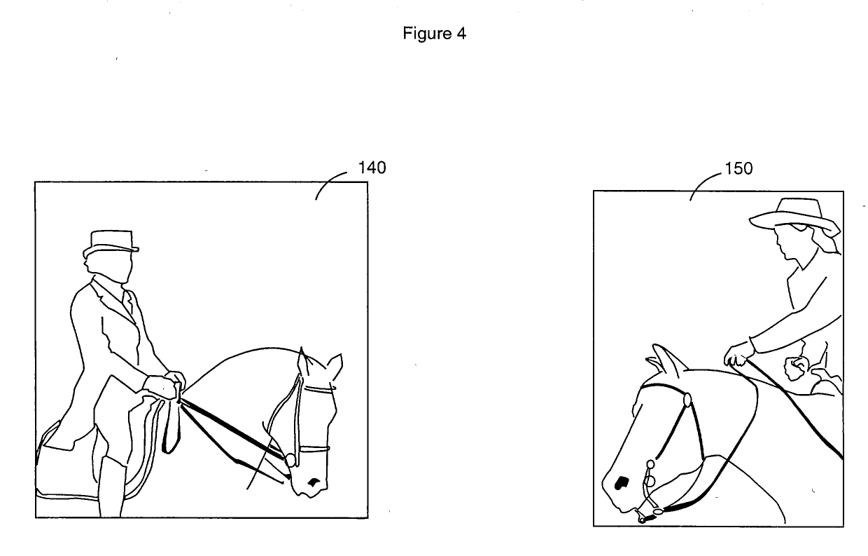

FIG. 4 shows two disciplines of horse riding with Dressage 140 and Western 150. Although the style in which the reins are held differs, the interaction between the rein, bridle and bits allow equal control and feedback from the horse.

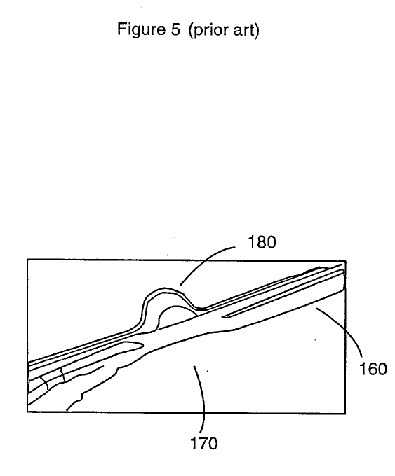

FIG. 5 shows a diagram of a prior art elastic 170 and leather 180 rein system 160 which is designed to absorb shock and excessive tension in the rein and horses' mouth. In such a system, excessive pulling on the rein will cause elastic 170 to stretch with increasing linear force as a function of linear motion. The relationship of increasing force to linear motion will absorb the pulling force until a maximum distance is reached, controlled by the rigid leather loop 180.

A reader skilled in the art will find it obvious that while such an apparatus may prevent shock damage to a horses' mouth due to an inexperienced rider, it will in no way teach a rider to learn the obvious issues and details taught in this text.

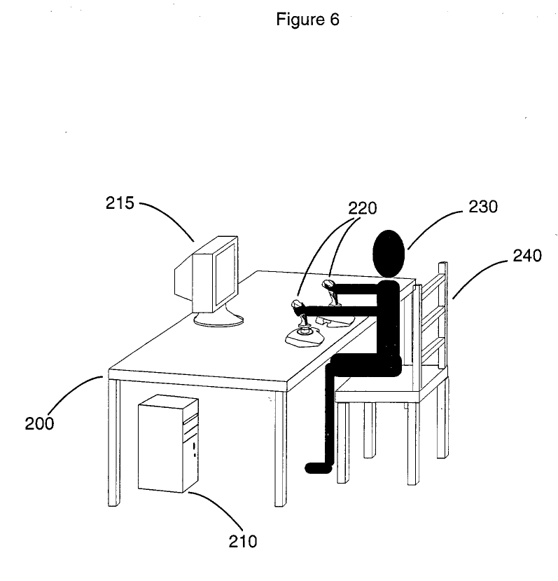

Referring now to FIG. 6, there is shown an embodiment of the present invention. There are numerous advantages of the present invention in that it does not require the learning horse rider to be in the presence of a real horse, there is no damage done to a horse through inexperienced riders tugging or pulling on the horses reins, the rider can concentrate on rein aids technique without concern for balance and many riding disciplines or techniques may be taught. A person skilled in the art will recognise that such an arrangement may be accomplished using “off-the-shelf” technological components or may be custom fabricated to include the present invention into the life size horse model disclosed earlier or other suitable arrangement.

This embodiment illustrates a user 230 seated on a chair 240 of appropriate height to allow correct posture in relationship to table 200 such that the users' hands may be placed on the position/feedback sensor(s) 220 in a manner that would approximate the equitation posture taught in Figures Two, Three and Four. A computer 210 is operably connected to the position/feedback sensor(s) 220 and a display 215 are placed in a position to approximate the location of the riding horses' head.

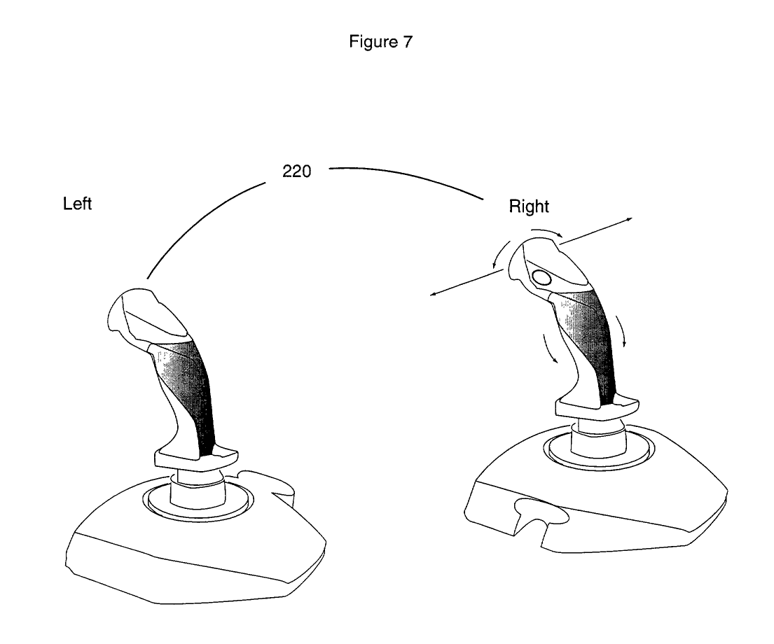

Referring now to FIG. 7, there is shown an enlarged view of the position/feedback sensor(s) described in FIG. 6 item 220. Such a sensor is able to translate user rein aids motions into force and position signals in a manner similar to actual equestrian rein aids. Additionally, many such sensor units are be equipped with feedback apparatus which provide resistance and motion in the sensor handle as a function of input signals from a controller means. A person skilled in the art will recognise that such position/feedback sensors are commonly known as “joysticks” although it is possible to sense position signals and provide resistance and motion feedback through other configurations that would not depart from the herein invention. Such alternate configurations would, for example, allow the position/feedback sensor apparatus to be constructed to appear as horse reins. Alternatively, one position/feedback sensor may be utilised.

In the preferred embodiment of the present invention, the controller means comprises a personal computer 210 and display means 215. During operation, the computer 210 receives hand equitation motion signals from the user 230 through the position/feedback sensor(s) 220. The computer 210 compares the present hand position signals to pre-determined rules and causes the display 215 to change visual simulations of a horse, moving within an area to change apparent motion and head position in relation to said position signals.

Simultaneously, the computer 210 will transmit feedback signals to the position/feedback sensor(s) 220 to simulate the resistance or motion that would be felt by a rider had they performed a similar motion on a real horse. Additionally, the computer 210 may change audio signals in relation to the said rules and visual simulations. For example, a user signalling a horse to stop may cause the sound of horse hoof movement to stop.

A reader skilled in the art will recognise that by developing adequate rules, visual, audio and feedback simulations, a simple, or more realistic equitation training system may be devised. It is an intention of the present invention to allow equestrian training to be conducted by users in a home environment as well as through more sophisticated simulations when incorporated within realistic horse sized models that may be used in a professional training facility.

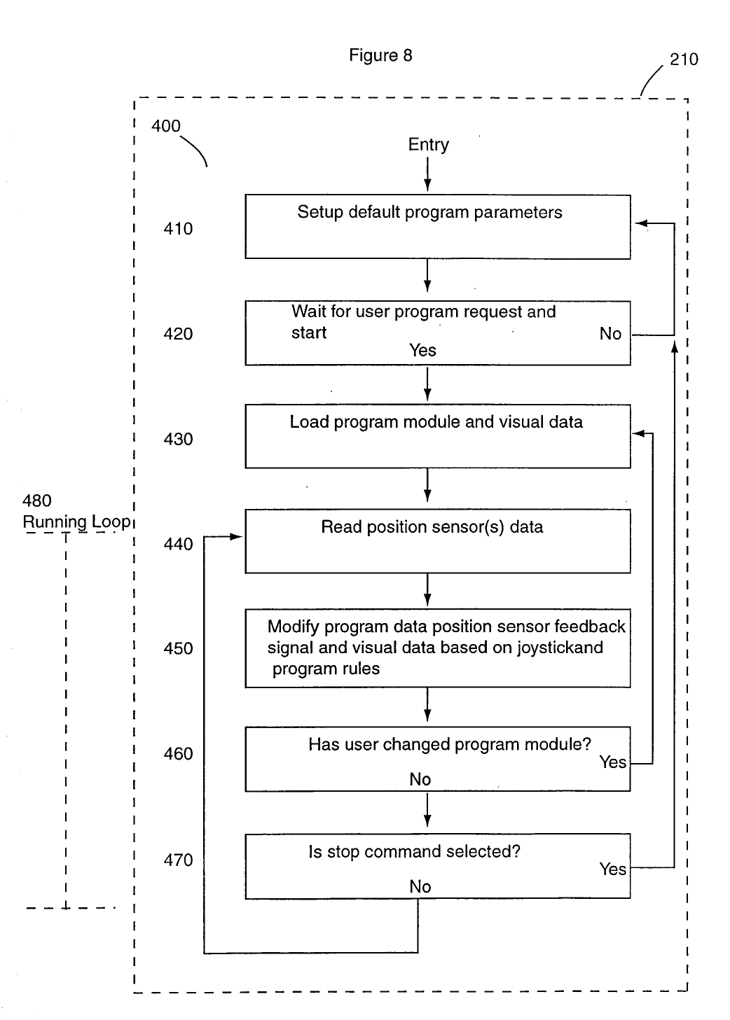

Referring now to FIG. 8, a flow chart of the operating mode sequence 400 of controller 210 is shown. When controller 210 is activated entry into operating mode sequence 400 is started. Controller 210 executes step SETUP DEFAULT PROGRAM PARAMETERS 410 configuring visual data on display 215 as well as audio and initial position/feedback sensor(s) 220 position and resistance level. Controller 210 then advances to step WAIT FOR USER PROGRAM REQUEST AND START 420. If no start command is received, controller 210 will loop back to step SETUP DEFAULT PROGRAM PARAMETERS 410 until a start command is received. When a start command is received, controller 210 advances to step LOAD PROGRAM MODULE AND VISUAL DATA 430. It will be apparent to a reader skilled in the art, that the controller 210 may be requested to load different simulations or rules at this step. For example, the user may wish to practice Dressage rein aids techniques which would cause a visual simulation and background appropriate with the Dressage technique 140.

Upon loading said program module and visual data, controller 210 will advance to step READ POSITION SENSOR(S) DATA 440 wherein current X, Y, Z axis data will be sampled and transmitted to controller 210. Controller 210 will then advance to step MODIFY PROGRAM DATA, JOYSTICK FEEDBACK SIGNAL, AUDIO AND VISUAL DATA BASED ON POSITION SENSOR(S) DATA AND PROGRAM RULES 450. A reader skilled in the art will recognise that this step involves comparing the current position sensor position and comparing this to a set of rules indicative of what a real horse would do given similar rein motion. Such a comparison would result in the controller 210 outputting data or signals that may change the horses position relative to the user and background on the display 215, modify sound as previously described and transmit changes in position sensor feedback resistance or position. Upon completion of step MODIFY PROGRAM DATA, POSTIOIN SENSOR FEEDBACK SIGNAL, AUDIO AND VISUAL DATA BASED ON POSITION SENSOR(S) DATA AND PROGRAM RULES 450 the controller 210 will advance to step HAS USER CHANGED PROGRAM MODULE? 460. If the user has changed the program module, the controller 210 will loop back to step LOAD PROGRAM MODULE AND VISUAL DATA 430. If the user has not changed the program module, the controller 210 will advance to step IS STOP COMMAND SELECTED? 470. If the user has selected the stop command, the controller will loop back to step SETUP DEFAULT PROGRAM PARAMETERS 410. If the user has not selected the stop command the controller 210 will loop back to step READ POSITION SENSOR(S) DATA 440.

If no stop command is selected a running loop 480 is formed wherein execution of the steps contained within the loop will cause the user 230 to interact with herein described apparatus so as to cause display, audio and feedback stimuli to occur in real time as if riding a real horse:

Further, a person skilled in the art will be familiar with the execution of controller, sequence steps as described above, including the use of logic decision branches and running loops.

Numerous modifications, variations and adaptations may be made to the particular embodiments of the invention described above without departing from the scope of the invention, which is defined in the claims.

What is claimed is:

1. An apparatus incorporating a control system and force and/or position feedback sensor apparatus for determining the orientation, motion and related sensing stimuli required to simulate correct rein aids and hand placement of various equitation disciplines, the apparatus comprising:
one or more force and/or position sensor(s), operably coupled to a controller means;
A controller means, coupled to receive data from said force and/or position sensor means and for comparing said force and/or position data to previously stored rules and data, generating output signals based on said comparison(s) and, said output signals comprising a position feedback signal coupled to a stimulator means, and further coupled to a display and audio generation means;
A stimulator means coupled to create motion and resistance feedback stimuli to the force and/or position sensor(s) means in relation to said controller output signal.

2. An apparatus as defined in claim 1, wherein the force and/or position sensor(s) includes a position sensing joystick.

3. An apparatus as defined in claim 1, wherein the force and/or position sensor(s) includes a position sensing joystick and feedback stimulator means.

4. An apparatus as defined in claim 1, wherein the force and/or position sensor(s) includes a force sensing joystick.

5. An apparatus as defined in claim 1, wherein the force and/or position sensor(s) includes a force sensing joystick and feedback stimulator means.

6. An apparatus as defined in claim 1, wherein the force and/or position sensor(s) includes a linear position sensing potentiometer.

7. An apparatus as defined in claim 1, wherein the force and/or position sensor(s) includes a linear force sensing potentiometer.

8. An apparatus as defined in claim 1, wherein the force and/or position sensor(s) includes a magnetostrictive sensor.

9. An apparatus as defined in claim 1, wherein the controller means includes a personal computer, display and audio generation means.

10. An apparatus as defined in claim 1, wherein the stimulator means includes a linear actuator means.

11. An apparatus as defined in claim 1, wherein the stimulator means includes an electric solenoid means.

12. An apparatus ad defined in claim 1, wherein the stimulator means includes an electric motor means.

13. A method incorporating a control system and force and/or position feedback sensor apparatus for determining the orientation, motion and related sensing stimuli required to simulate correct rein aids and hand placement of various equitation disciplines, the method comprising:
one or more force and/or position sensor(s), operably coupled to a controller means;
A controller means, coupled to receive data from said force and/or position sensor means and for comparing said force and/or position data to previously stored rules and data, generating output signals based on said comparison(s) and, said output signals comprising a position feedback signal coupled to a stimulator means, and further coupled to a display and audio generation means;
A stimulator means coupled to create motion and resistance feedback stimuli to the force and/or position sensor(s) means in relation to said controller output signal;
the method comprising the steps of;
(e) set-up default program parameters;
(f) wait for user program request and start command;
(g) load program module and audio/visual data;
(h) read position sensor(s) data
(e) Modify program data, position sensor feedback signal, audio and visual data based on position sensor(s) data and program rules.
